(19) United States
(12) Patent Application Publication
(10) Pub. No.: US 2004/0052520 A1
(43) Pub. Date: Mar. 18, 2004

(54) Path protection in WDM network

(76) Inventors: Ross Halgren, Collaroy Plateau (AU); Brian Robert Brown, Collaroy (AU)

Correspondence Address: CHRISTIE, PARKER & HALE, LLP, 350 WEST COLORADO BOULEVARD, SUITE 500, PASADENA, CA, 91105, US

(21) Appl. No.: 10/071,218

(22) Filed: Feb. 7, 2002

(51) Int. Cl. H04B 10/08; H04J 14/02

(52) U.S. Cl. 398/5; 398/2; 398/154; 398/83

(57) ABSTRACT

A node for use in a WDM optical network, the node comprising a tributary receiver unit for receiving a data signal distributed via the WDM optical network and destined for said node, a path protection switching unit for switching receipt of said data signal at the tributary receiver unit from a working path to a protection path of the WDM optical network, and a control unit for the path protection unit, wherein the control unit comprises a multi rate clock data recovery (CDR) device arranged, in use, to detect a loss of lock (LOL) in the data signal received at the tributary receiver unit based on a comparison of an actual data rate received and a pre-programmed reference rate for said data signal.

### FIELD OF THE INVENTION

The present invention relates broadly to a node for use in a WDM optical network, to a method of conducting path protection in a WDM network, to a method of conducting fault notification in a WDM network, and to a WDM network.

### BACKGROUND OF THE INVENTION

Broadband fibre-optics telecommunication networks must by definition carry large volumes of customer traffic. Failures can therefore be very expensive and Service Level Agreements (SLAs) are established between customers and Telcos to guarantee a specified network availability. Typical Telco availability requirements are classified as five nines or 0.99999. This equates to a down-time of no more than 5 minutes per year. A typical failure event involving human (technical) intervention to repair requires of the order of hours for a equipment failure and of the order of days for a fibre cable failure (usually damage from trench diggers etc). To achieve less than 5 minutes down time per annum therefore requires redundant (unused paths or path capacity) and automated path protection schemes.

In contrast to single-protocol, single-wavelength synchronous optical networks (SONET)/synchronous digital hierarchy (SDH), Fibre Distributed Data Interface (FDDI) and resilient packet ring (RPR) networks, wavelength division multiplexing (WDM) networks are aimed at multi-protocol support. Transparency to the reconfiguration schemes of the networks and protocols that pass over the WDM channels is required. The networks and protocols that use the WDM channels for transport may have disparate SLA requirements, topologies (point-point, ring, mesh) path protection schemes and protection switching times. The WDM network should be able to support all of these requirements, which generally equates to being able to support the worst-case requirements. In particular, if SONET/SDH networks must detect a path failure and reconfigure in 50 ms, then to avoid race conditions, oscillations, etc, WDM networks aim to achieve path fault detection and path switching in less than 10 ms. In doing so, the WDM network can detect and bypass a fault before an attached SONET/SDH network has time to detect that there is anything wrong. WDM networks should also be capable of simultaneously applying different protection schemes to each WDM channel to match the path-protection requirements of the network using that WDM channel.

The present invention, in at least preferred embodiments, seeks to provide a novel fault detection and fault notification technique, which is suitable for path protection applications in WDM networks.

### SUMMARY OF THE INVENTION

In accordance with a first aspect of the present invention there is provided a node for use in a WDM optical network, the node comprising a tributary receiver unit for receiving a data signal distributed via the WDM optical network and destined for said node, a path protection switching unit for switching receipt of said data signal at the tributary receiver unit from a working path to a protection path of the WDM optical network, and a control unit for the path protection unit, wherein the control unit comprises a multi rate clock data recovery (CDR) device arranged, in use, to detect a loss of lock (LOL) in the data signal received at the tributary receiver unit based on a comparison of an actual data rate received and a pre-programmed reference rate for said data signal.

Preferably, the CDR device is further arranged, in use, to detect a loss of signal (LOS) in the data signal received at the tributary receiver unit. The CDR device may comprise a IR optical receiver element and a 2R binary detection element for detecting the LOS.

The control unit advantageously further comprises a signal quality detector unit for monitoring the quality of the data signal received at the tributary receiver unit.

In one embodiment, the switching unit comprises an optical switch, and the control unit and the tributary receiver unit are located at the output side of the optical switch.

In one embodiment, the switching unit comprises an electrical switch, the control unit comprises at least two CDR devices and associated signal quality detectors, all located on the input side of the electrical switch, and the tributary receiver unit is located on the output side of the electrical switch and arranged as an electrical receiver, and a pair of one CDR device and one associated signal quality detector is connected, in use, to the working path, and another pair of one CDR device and one associated signal quality detector to the protection path. Accordingly, the quality of the signal received via the protection path can be known before the protection switch is activated, which can allow more robust path switching algorithms to be implemented. This can result in a lower occurrence of “bouncing” back and forth between paths when both paths are faulty or of insufficient quality.

The node may further comprise one or more first network interface units arranged, in use, to demultiplex an incoming WDM optical signal and to convert the incoming WDM optical signal into a plurality of electrical channel signals, a plurality of 3R regeneration units for regenerating the electrical channel signals, and one or more second network interface units arranged, in use, to convert and multiplex at least one of the electrical channel signals into an outgoing WDM optical signal.

In such embodiments, each 3R regeneration unit is preferably arranged, in use, to detect a LOL in its associated electrical channel signal and to force its output to a substantially static state in response to detecting the LOL. The 3R regeneration unit is advantageously further arranged to detect a LOS in its associated electrical channel signal.

Each 3R regeneration unit may further be arranged, in use, to create a laser disable output signal in response to detecting the LOL or LOS, and to transmit the laser disable output to a transmitter laser of the second network interface unit, wherein the transmitter laser is arranged, in use, to switch its laser output to a 3^{rd}, non-binary state in response to the laser disable signal.

Each 3R regeneration unit is preferably arranged, in use, to detect the 3^{rd}, non binary state in its associated electrical channel signal received from another node, and to maintain its electrical output at the last received binary state when detecting the 3^{rd}, non-binary state. In one embodiment, each 3R regeneration unit comprises a 2R regeneration component arranged, in use, such that a gap exists between a threshold-low binary detection state and a threshold-high binary detection state, and the 3^{rd}, non-binary state is chosen, in use, such that it falls within said gap.

In accordance with a second aspect of the present invention, there is provided a node for use in a WDM optical network, the node comprising one or more first network interface units arranged, in use, to demultiplex an incoming WDM optical signal and to convert the incoming WDM optical signal into a plurality of electrical channel signals, a plurality of 3R regeneration units for regenerating the electrical channel signals, one or more second network interface units arranged, in use, to convert and multiplex at least one of the electrical channel signals into an outgoing WDM optical signal, and wherein each 3R regeneration unit is arranged, in use, to detect a LOL in its associated electrical channel signal and to force its output to a substantially static state in response to detecting the LOL.

Each 3R regeneration unit is advantageously further arranged to detect a LOS in its associated electrical channel signal.

Each 3R regeneration unit may further be arranged, in use, to create a laser disable output signal in response to detecting the LOL or LOS, and to transmit the laser disable output to a transmitter laser of one of the second network interface units, wherein the transmitter laser is arranged, in use, to switch its laser output to a 3^{rd}, non-binary state in response to the laser disable signal.

Each 3R regeneration unit is preferably arranged, in use, to detect the 3^{rd}, non binary state in its associated electrical channel signal received from another node, and to maintain its electrical output at the last received binary state when detecting the ³rd, non-binary state. In one embodiment, each 3R regeneration unit comprises a 2R regeneration component arranged, in use, such that a gap exists between a threshold-low binary detection state and a threshold-high binary detection state, and the 3^{rd}, non-binary state is chosen, in use, such that it falls within said gap.

In accordance with a third aspect of the present invention there is provided a method of conducting path protection in a WDM optical network, the method comprising the steps of receiving a data signal at a tributary receiver unit of a network node, detecting a loss of lock (LOL) in the data signal received at the tributary receiver unit based on a comparison of an actual data rate received and a reference rate for said data signal, and switching receipt of said data signal at the tributary receiver unit from a working path to a protection path of the WDM optical network.

Preferably, the step of detecting the LOL comprises utilising a multi rate clock data recovery (CDR) device.

In one embodiment, the method further comprises the step of detecting a loss of signal (LOS) in the data signal received at the tributary receiver unit. The step of detecting the LOS may comprise utilising the CDR device for detecting the LOS.

The method advantageously further comprises monitoring the quality of the data signal received at the tributary receiver unit.

In one embodiment, the step of switching to the protection path comprises utilising an optical switch, wherein the tributary receiver unit is arranged as an optical receiver and is located at the output side of the optical switch.

In another embodiment, the step of switching to the protection path comprises utilising an electrical switch, and the method comprises the steps of detecting LOLs and/or LOSs and monitoring the quality of the data signals on both the working and the protection path before the electrical switch, and wherein the tributary receiver is located on the output side of the electrical switch and is arranged as an electrical receiver.

The method may further comprise the steps of, at the network node, demultiplexing an incoming WDM optical signal and converting the incoming WDM optical signal into a plurality of electrical channel signals, regenerating the electrical channel signals utilising 3 R regeneration, and converting and multiplexing at least one of the electrical channel signals into an outgoing WDM optical signal.

In such embodiments, the step of regenerating the electrical channel signals preferably comprises detecting LOLs in the individual electrical channel signals and to force an output of the 3R regeneration for individual channels to a substantially static state in response to detecting the LOL. The step of regenerating the electrical channel signals advantageously further comprises detecting a LOS in the individual electrical channel signals.

The method may further comprise the steps of creating a laser disable output signal in response to detecting the LOL or LOS, and switching the output of a transmitter laser of the second network interface unit associated with one of the channel signals to a 3^{rd}, non-binary state in response to the laser disable signal.

The method preferably comprises the step of detecting the ³rd, non binary state in the electrical channel signals received and converted from another node, and maintaining an electrical output of the 3R regeneration at the last received binary state when detecting the 3^{rd}, non-binary state. In one embodiment the 3^{rd}, non-binary state is chosen, in use, such that it falls within a gap between a threshold-low binary detection state and a threshold-high binary detection state in the 3R regeneration.

In accordance with a fourth aspect of the present invention there is provided a method of conducting fault notification in a WDM optical network from one network node to another, the method comprising the steps of, at said one network node, demultiplexing an incoming WDM optical signal and converting the incoming WDM optical signal into a plurality of electrical channel signals, regenerating the electrical channel signals utilising 3R regeneration, and converting and multiplexing at least one of the electrical channel signals into an outgoing WDM optical signal, and wherein the step of 3R regenerating the electrical channel signals comprises detecting LOLs in the individual electrical channel signals and forcing the output of the 3R regeneration for individual electrical channels to a substantially static state in response to detecting the LOL.

The step of regenerating the electrical channel signals advantageously further comprises detecting a LOS in the individual electrical channel signals.

The method may further comprise the steps of creating a laser disable output signal in response to detecting the LOL or LOS, and switching the output of a transmitter laser of the second network interface unit associated with one of the channel signals to a 3^{rd}, non-binary state in response to the laser disable signal.

The method preferably comprises the step of detecting the 3^{rd}, non binary state in the electrical channel signals received and converted form another node, and maintaining an electrical output of the 3R regeneration at the last received binary state when detecting the 3^{rd}, non-binary state. In one embodiment the 3^{rd}, non-binary state is chosen, in use, such that it falls within a gap between a threshold-low binary detection state and a threshold-high binary detection state in the 3R regeneration.

In accordance with a fifth aspect of the present invention there is provided a WDM network comprising a node as defined in the first or second aspects.

In accordance with a sixth aspect of the present invention there is provided a WDM network arranged, in use, to implement a method as defined in the third or fourth aspects.

### BRIEF DESCRIPTION OF THE DRAWINGS

Preferred embodiments of the present invention will now be described, by way of example only, with reference to the accompanying drawings.

FIG. 1 All-Optical Switching Node, embodying the present invention.

FIG. 2 All-Optical Mesh Network—Uni-directional Connections embodying the present invention.

FIG. 3 Integrated All-Optical Cross-Connect & Path Protection Switch embodying the present invention.

FIG. 4 Separate All-Optical Cross Connect & Path Protection Switches embodying the present invention.

FIG. 5 Dual 3 R Receivers on Input Side of Electrical Path Protection Switch embodying the present invention.

FIG. 6 All Optical Mesh Network with Cable Damage embodying the present invention.

FIG. 7 Optical Protection Switch Activated—New Working Path embodying the present invention.

FIG. 8 All-Optical Mesh Network—Fault Bypassed with New Working Path embodying the present invention.

FIG. 9 OEO Switching Node embodying the present invention.

FIG. 10 Mesh Network of OEO Switching Nodes embodying the present invention.

FIG. 11 OEO Mesh Network with Cable Damage embodying the present invention.

FIG. 12 OEO Mesh Network—Fault Bypassed with New Working Path embodying the present invention.

FIG. 13 Reconfigurable OADM Node—Path Protection Switch & 3R Receiver embodying the present invention.

FIG. 14 All-Optical Ring Network—Working Path Operational embodying the present invention.

FIG. 15 Cable Damage in Working Path of All-Optical Ring Network embodying the present invention.

FIG. 16 New Working Path—All Optical Ring Network Failure Bypassed embodying the present invention.

FIG. 17 Reconfigurable OEO Add/Drop WDM Node—Path Protection Switch & 3R Receiver embodying the present invention.

FIG. 18 Ring Network of Reconfigurable OEO Nodes—Working Path Operational embodying the present invention.

FIG. 19 Cable Damage in Working Path of OEO Ring Network embodying the present invention.

FIG. 20 New Working Path—OEO Ring Network Failure Bypassed embodying the present invention.

FIG. 21 Optical Receiver and Multi-Rate CDR—Showing Inputs & Outputs embodying the present invention.

FIG. 22 CDR Normal Operating State embodying the present invention.

FIG. 23 CDR—Signal above Threshold but in Loss of Lock State—Pseudo Data Propagated embodying the present invention.

FIG. 24 CDR—Signal above Threshold but in Loss of Lock State—Pseudo Data Inhibited embodying the present invention.

FIG. 25 CDR—Signal below Threshold and in Loss of Lock State—Pseudo Data Inhibited embodying the present invention.

FIG. 26 Fault Event with Pseudo Data being forwarded from CDR to CDR embodying the present invention.

FIG. 27 Fault Event with CDR#5 LOL Alarm Disabling CDR#5 Output embodying the present invention.

FIG. 28 Fault Event with CDR#5 LOS Alarm Disabling CDR#5 Output embodying the present invention.

### DETAILED DESCRIPTION OF THE EMBODIMENTS

All-Optical Mesh Network Embodiments

(a) End-End Connection Establishment

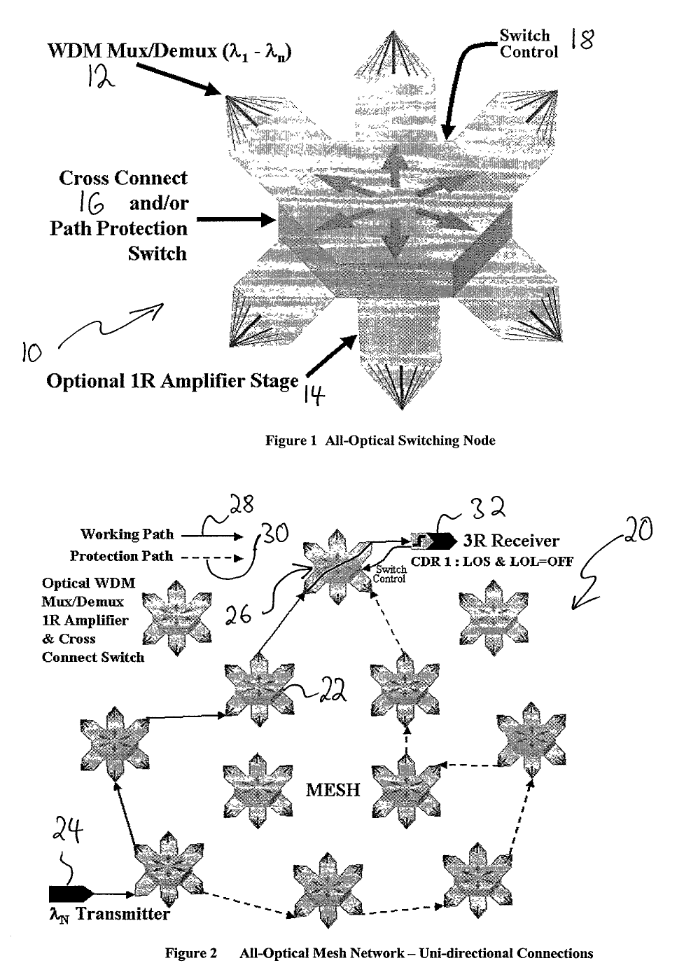

FIG. 1 illustrates an all-optical (OOO) switching node 10 comprising: Optical WDM multiplexer/demultiplexer ports e.g. 12 (6 ports per node shown, but not limited to this number); Optical Amplification e.g. 14 (1R signal level regeneration) to compensate for link losses; Optical Cross Connect & optional Path Protection Switching 16; and a Control input 18 for changing the switch configuration.

For the purpose of this invention, WDM encompasses all forms of wavelength division multiplexing, including Dense WDM & Course WDM. For a given network application, the choice may be dictated by capacity requirements or optical amplification requirements for example.

FIG. 2 illustrates an all-optical mesh network 20, comprising all-optical (OOO) switching nodes e.g. 22.

A Transmitter 24 is shown in FIG. 2, sending data on wavelength λ_{N} to a remote Receiver node 26 via a “Working Path” 28 and a “Protection Path” 30. Both paths 28, 30 are pre-established or reserved via connection-signalling. In normal operation, both paths 28, 30 generally have equivalent performance, so it is arbitrary which is selected as the “Working Path” and which is selected as the “Protection Path” at any given time. Shown in FIG. 2 is a uni-directional connection. The transmitter 24, receiver 32, working and protection paths 28, 30 will be replicated in the opposite direction of data flow for bi-directional connections in an alternative embodiment. For a bi-directional connection, it is not critical for the forward and reverse path routes to be the same.

The remote Receiver 32 includes 3R regeneration, meaning that it receives the optical signal, converting it into the electrical domain, amplifies the electrical signal (1R), re-shapes the signal—generally to fixed binary signal levels with appropriate rise/fall time (2R), and then re-times the 2R data—nominally in the centre of each bit (3R) with a clock derived from the 2R data transitions. The latter function is called Clock/Data Recovery (CDR) and CDR devices are available for this purpose. Some CDR devices also include elements of 1R and 2R functionality.

In WDM applications, multi-rate CDRs exist which can be software configured to lock onto most or all standard data rates (SONET OC-n, SDH STM-m, Gigabit Ethernet, Fibre Channel, ESCON, etc). This capability is desirable since switched WDM networks are required to support any standard protocol and data rate on any wavelength, and this mapping of protocols to wavelengths may change with time.

Intermediate and end-point CDRs are configured to the required data rate as part of the end-end connection establishment phase, for both the Working and Protection Paths 28, 30.

(b) Signal Fault Detection Mechanisms

The 3R Receiver 32 is capable of detecting two failure events:

Loss of Signal (LOS)—meaning that the 1R signal level has dropped below a pre-set threshold for at least one bit period or several bit periods for greater noise immunity; and

Loss of Lock (LOL)—meaning that the 3R signal cannot be expected to have low edge jitter or low bit error rate since the derived clock has a different average frequency to that of the incoming data rate or has a larger than acceptable phase error compared to the incoming data transitions.

In this example, the all-optical switching nodes e.g. 22 do not require CDRs since they can employ 1R amplification, although to prevent unacceptable random noise jitter accumulation, there should as a rule of thumb, be a 3R regenerator node after no more than ten 1R optical amplifier nodes.

As shown in FIG. 2, the Working Path 28 is operating normally and as a result, the 3R Receiver 32 has its CDR#1 LOS and LOL alarms both OFF, meaning that the input signal level is greater than the present threshold and the data and clock transitions have a constant and acceptable phase relationship. Under such conditions, it can be inferred that the Bit Error Rate (BER) is less than some value (eg, <10⁻³) but it cannot be inferred that the BER is acceptable. Additional “performance monitoring” logic can be added in other embodiments to provide this extra information that could be used as part of the best-path selection and associated path-switching process.

Whilst all nodes may include tributary ports, only the tributary ports for a single end-end service are shown for simplicity.

(c) Path Switching Mechanisms

As shown in FIG. 3, a 1×2 switch function is required to select either the Working Path 28 or the Protection Path 30. This is called the “path protection switch” application of the optical switch 16. The combination of the Transmitter 24 (FIG. 2) broadcasting the same data on both Working and Protection paths 28, 30 and the operation of a path protection switch, to direct an acceptable quality signal to the Receiver 32 is a particular implementation of 1+1 path protection switching that can achieve the fastest possible path fault detection, failure reporting and path switching times.

As part of this invention, the path protection switch is directly or indirectly controlled based on the state of the LOS and LOL alarms produced by the 3R Receiver 32.

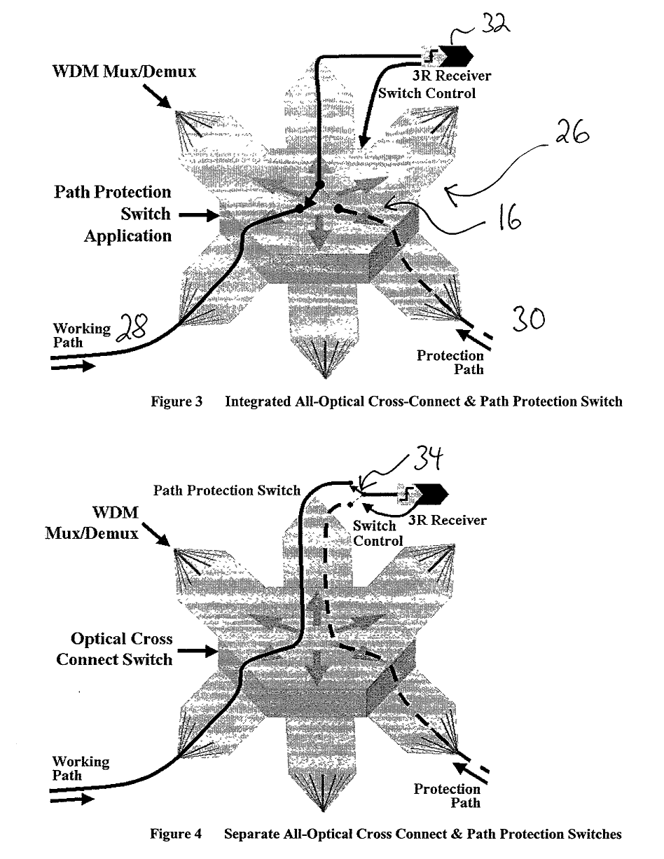

In FIG. 3, the optical path protection switch application is shown overlaid onto the optical cross-connect switch 16. That is, the optical cross connect switch 16 performs this function as a special case. This is one implementation option. Another option, as shown in FIG. 4, is for the cross-connect switch 16 to forward both the Working and Protection paths 28, 30 to a dedicated path protection switch 34 that is associated with the 3R Receiver 32. In both cases, the 3R Receiver 32 is on the output side of the switch.

In FIG. 3 and FIG. 4, in the event of a failure in the Working Path 28, the quality of the signal received via the Protection Path 30 is not known until the optical protection switch connects the Protection Path 30 to the 3R Receiver 32. After a short signal level detection and clock acquisition period, the signal level and clock synchronization will either meet or not meet the preset signal quality requirements. LOS and LOL alarms will ideally go to the OFF state, indicating that the signal is good. However, if either alarm goes to the ON state, then the signal on the Protection Path is deemed poor and the protection switch will either have to switch to the other path 28 again, or will not switch again, but will instead, report the fault to the Network Management System (not shown) and let it or a human decide what action to take. The algorithm that makes the initial decision re what to switch and when can be run entirely at the 3R Receiver 32, thus reducing the time to report any failures and hence reducing the time to switch the Receiver 32 to a (hopefully) better path, thus increasing the network availability. This path switching algorithm can be very simple (eg, having no de-bounce logic) or more complex (eg, including path-bias options) in different embodiments.

In FIG. 5, as a preferred embodiment, two 3R Receivers, 36, 38 associated CDRs and signal quality detectors are relocated to the input side of a electrical path protection switch 40. The benefit of this implementation option over that shown in FIG. 4 is that the quality of the signal received via the Protection Path 30 is known before the protection switch 40 is activated and therefore allows more robust path switching algorithms to be implemented. This can result in a lower occurrence of “bouncing” back and forth between paths 28, 30 when both paths or the Transmitter 24 (FIG. 2) itself may be faulty.

(d) Example Failure in Working Path

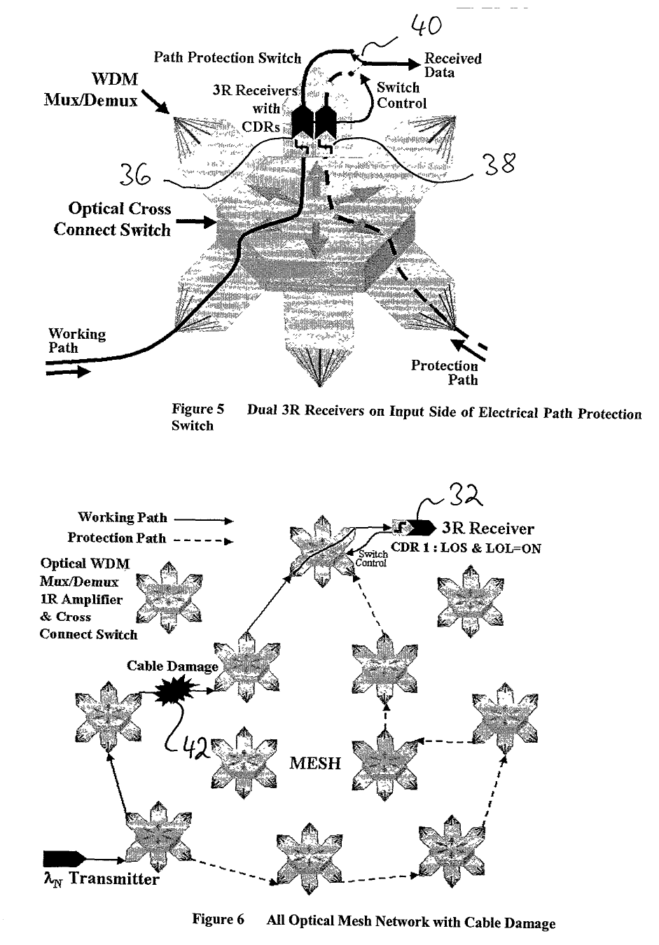

FIG. 6 illustrates a cable damage event 42 in the Working Path 28 and the resultant change in status of the 3R Receiver 32 LOS and LOL alarms from OFF to ON due to the signal level dropping below the preset threshold for at least one bit-period and the clock going out of phase synchronization with the data transitions.

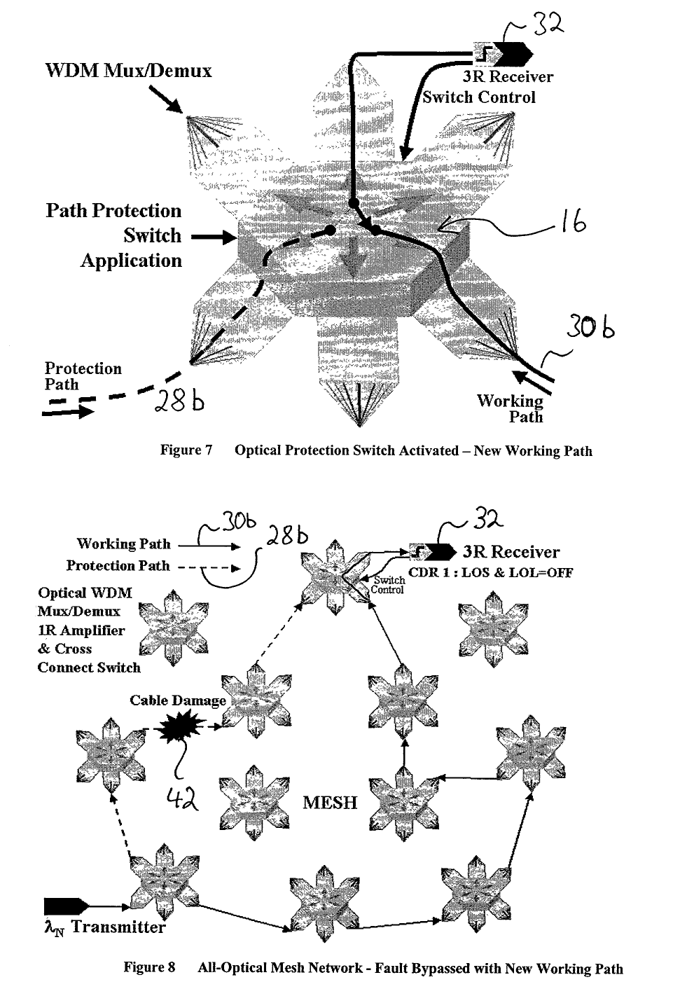

FIG. 7 illustrates the 3R Receiver 32 alarm outputs causing the optical path protection switch application of cross-connect switch 16 to connect the Protection Path 30 to the 3R Receiver 32, due to signal fault detection in the Working Path 28. Once this happens, the path 30 to which the 3R Receiver 32 is connected becomes the new Working Path and the other path becomes the new Protection Path. Until the previous failure is repaired, the new Protection Path is not actually useful for protecting the signal (a limitation of 1+1 protection).

FIG. 8 illustrates the 3R Receiver 32 detecting a good signal again, via the new Working Path 30b and thus changing the status of the LOS and LOL alarms back to OFF.

(e) Signal Fault Detection Algorithms

In an all-optical network with 1R amplification in the signal path, it is possible that a break in the fibre as shown in FIG. 6 can occur and this will not be detected as a Loss of Signal (LOS) due to spurious optical amplifier noise substituting for the data and exceeding the LOS threshold level.

In the example embodiment of the present invention, the LOL alarm can be utilised to recognise that the spurious optical signal being received (due to the optical amplifiers for example) does not correlate with the supported protocol and the associated data rate that was pre-programmed into the CDR of the 3R Receiver 32 during connection establishment.

The “signal fault detection algorithm” defined in the example embodiment is that if either the LOS or LOL alarms goes to the ON state, then the signal is deemed to be of unacceptable quality and thus to have failed. Whilst it would be sufficient to use only the LOL alarm to detect a fault, the benefit of using both LOS and LOL alarms in the example embodiment is that under different conditions, the LOS alarm may be detected before the LOL alarm, and visa versa. Detecting either alarm in the ON-state therefore results in a shorter fault detection time under a wide range of fault conditions, protocols and data rates.

(f) Path Switching Algorithms

The signal fault detection alarm output is fed into another part of the 1+1 path protection algorithm which decides whether to switch from the Working Path to the Protection Path or not. The “path switching algorithm” will be based on past history and other path bias-options pre-programmed by Network Management in various embodiments of the present invention.

Optical-Electrical-Optical (OEO) Mesh Network

(g) OEO Switching Nodes

FIG. 9 illustrates a 6-port OEO switching node 44, comprising a WDM multiplexer and demultiplexer on each port, e.g. 46 a optical receiver and CDR on each input wavelength illustrated at e.g. numeral 48, a CDR and wavelength specific optical transmitter on each output wavelength, also illustrated at e.g. numeral 48 and a control input 50 for changing the electrical switch matrix 52 connections. In FIG. 9, the symbol at numeral 48 represents a 3R multi-rate CDR retiming function (the 1R optical receiver and 2R binary detection functions are inferred).

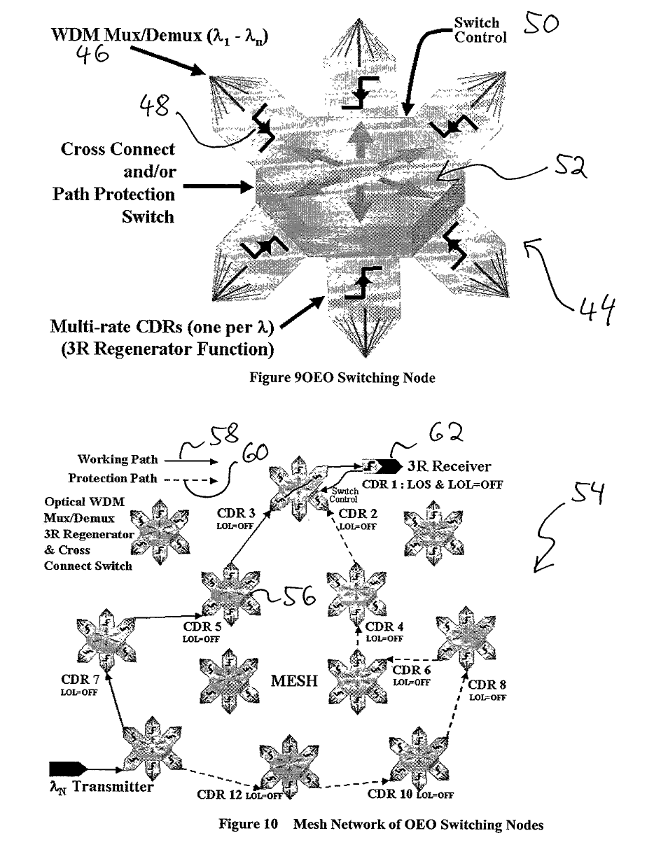

FIG. 10 illustrates a Mesh network 54, in which each node e.g. 56 is a OEO switching node rather than a OOO switching node.

Since each node in FIG. 10 is a OEO switching node e.g. 56, there is, in the example embodiment, a LOS and LOL alarm output generated for each wavelength received and generally, there will be a LOL alarm generated at the Transmit CDR just prior to each wavelength transmitter. The Transmit CDR can be used to reduce the edge jitter caused by imperfect electronic switching components and electrical transmission paths within the OEO node e.g. 56. For simplicity, only the 3R Receiver LOL alarm status outputs are shown in FIG. 10 for the OEO switching nodes e.g. 56. The 3R Receiver LOS and Transmit CDR LOL alarms exist and may be used as part of the switching algorithm, but are not shown.

As shown in FIG. 10, all the working path 58 is operating normally and so all the OEO node LOL alarms are in the OFF state (represented as CDRs 3, 5 & 7 for the Working Path 58 and CDRs 2, 4, 6, 8, 10 &12 for the Protection Path 60). It can be assumed for the purpose of this description, that all the LOS alarms are also in the OFF state for all the OEO nodes e.g. 56. Similarly, the end-node 3 R Receiver 62 LOS and LOL (CDR#1) alarms are in the OFF state, indicating that the Working Path 58 is operating normally.

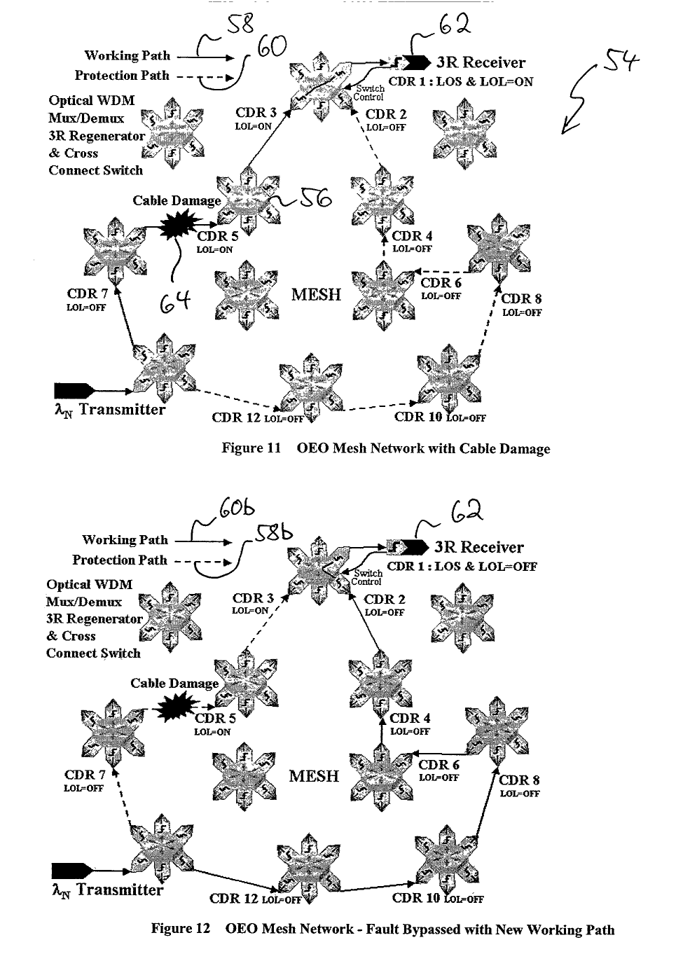

FIG. 11 illustrates the effect of cable damage 64 in the Working Path 58 of the OEO Mesh Network 54. At the OEO node 56 immediately downstream of the cable damage 64, the CDR#5 LOL and associated LOS alarms specific to the end-end connection will change to the ON state (indicating fault detection). In fact, in the case of a cable break 64, similar alarms will occur for all wavelengths received at that port. There are however, many other failure mechanisms that affect only one wavelength (eg, optical receiver component failure) or a band of wavelengths (eg, filter damage).

It is an important aspect of the example embodiment that each wavelength connection within the WDM network 54 looks after itself, and does not rely on “summary alarms” resulting from multi-wavelength failure conditions. By enabling each wavelength connection to look after itself (through decentralized intelligence and fault notification), it is possible to achieve faster detection of single-wavelength failures and hence faster path protection switching and higher service availability.

For an OEO Network, implementation of a decentralized (wavelength-associated) fault detection and notification mechanism requires that failure conditions anywhere along the wavelength path be rapidly detected and signalled within the physical layer of the respective wavelength, to downstream neighbour nodes and ultimately the 3R Receiver 62 or the path protection switch application at the end of that wavelength path, since for the example embodiment, this is where the path protection switching decision and action will be made.

FIG. 11 shows that the fault detected by CDR#5 has indeed been propagated to CDR#3 and the end-node CDR#1 (all LOL Alarm states=ON). The process by which this fault condition is propagated down the wavelength path is however, non-trivial. For comparison, in the case of the all-optical (OOO) mesh network, the ability for optical amplifiers to generate spurious noise in place of lost signals was discussed above. The inability for the LOS detector to differentiate between real data and spurious noise was overcome with the additional LOL detector in an example embodiment.

In the case of OEO networks, a similar problem now occurs for the LOL detector. In this case, the CDR#5 immediately downstream of the fault condition (cable break 64 etc) will detect LOL, however, the CDR#5 can, without appropriate intervention, continue to clock erroneous (pseudo) data out at the pre-programmed data rate. This can look like valid data to downstream CDRs.

In a preferred embodiment, if there is loss of signal (due to a fibre break), then the CDR input should be static and if this is an invalid data condition, it will be automatically and rapidly propagated downstream to all other CDRs and the end-node Receiver 62. For the static data condition (all 1s or all 0s) to be invalid, it is highly desirable that all data be suitably encoded to remove the all 1s and all 0s data patterns. This can e.g. be done by converting them to other valid data patterns having a pre-defined maximum number of consecutive identical digits (1s and 0s) and the same number of 1s and 0s when averaged over a long interval. The optical receiver 3R Regenerator can then be AC-coupled to the 2R binary detector stage to maximize the dynamic range and sensitivity. Data encoding is normal practice and so it is possible for the static state to be interpreted as a fault and for this state to be propagated within the physical layer as a fault notification to downstream nodes.

Where the path failure is due to a faulty component, such as the optical receiver, then spurious noise may be applied to the input of the 2R binary detector stage and thence to the 3R retiming stage of the CDR. Data being clocked out of the CDR will actually be a 2R regenerated version of the spurious noise, which may look to the other downstream CDRs and the end-node Receiver CDR like valid data—especially given that this data may be arriving at a data rate that is within the lock range of the CDRs. As outlined in more detail below, this false-lock condition is overcome in a preferred embodiment by using the CDR LOL alarm to force the data output of the CDR to the static data condition. This is effectively an in-band, wavelength associated “fault notification” mechanism—which will be propagated rapidly to the end-node Receiver 62 where the path-switching decision will be made. This in-band (Physical Layer) fault notification mechanism is an important aspect of the preferred embodiment.

Having notified all downstream neighbour CDRs (CDR#3 in FIG. 11) along the same path and at the end-node Receiver 62, the Receiver 62 will finally change the LOL alarm to the ON state and subsequently, the path protection switch application will connect the Receiver 62 to the Protection Path 60 (i.e. new Working Path 60b and the Working Path 58 Protection Path 58b will lay dormant—waiting to be repaired. The end-node Receiver 62 LOS and LOL alarm states will then go to the OFF state if a good signal is received via this path. This is illustrated in FIG. 12.

One of the benefits of the OEO switching nodes embodiment is that prior to a path switching decision, the status of the working and protection paths 58, 60 can, like that shown in FIG. 5, be ascertained with a high level of confidence due to the presence of CDRs on all WDM inputs to the OEO nodes.

All-Optical Ring Network

(h) Reconfigurable OADM Nodes

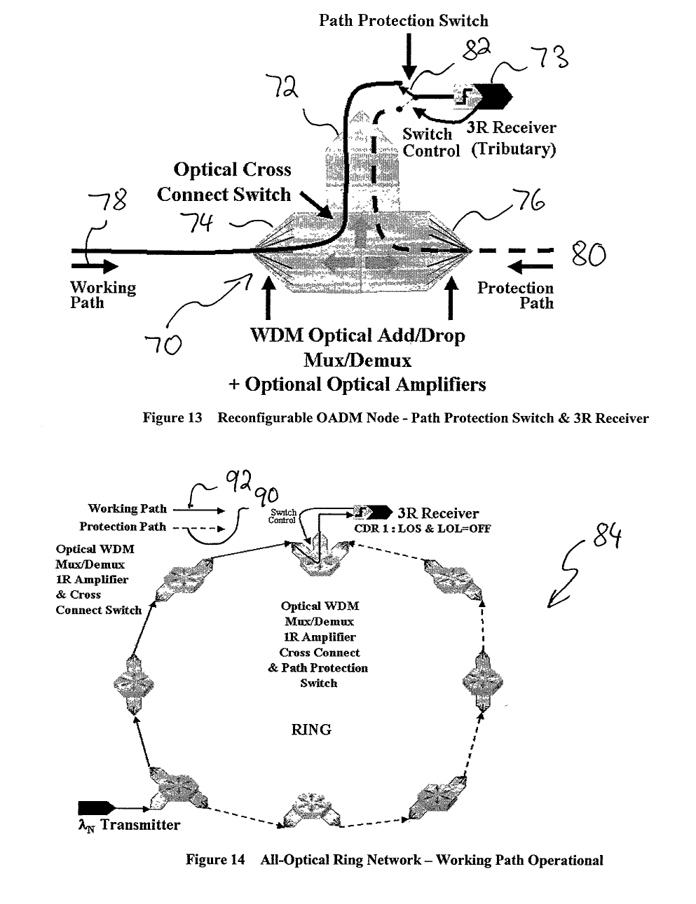

Since linear bus and ring network topologies are a subset of a mesh network topology, all that has been discussed in the previous embodiments automatically applies to linear bus and ring networks. Because of the popularity of optical ring networks in particular—led in the past by protocols such as SONET, SDH and FDDI, and in the future by Resilient Packet Ring (RPR), other embodiments of the present invention with a focus on the specific architecture of optical add/drop nodes in a ring network will now be described. FIG. 13 illustrates such a node 70.

As shown in FIG. 13, a typical ring node 70 has 3 ports:

1. A Tributary Port 72 through which one or more services connect to the ring, via wavelength-specific optical Transmitters (not shown) and broadband optical Receivers e.g. 73;

2. A West Port 74 which passes through-traffic on multiple wavelengths to the East Port 76 and/or to the Tributary port 72; and

3. A East Port 76 which passes through-traffic on multiple wavelengths to the West Port 74 and/or to the Tributary port 72.

In an all-optical WDM ring network, the nodes will generally add/drop wavelengths using a combination of optical mux/demux filters, optical splitters and protection switches. These are referred to as Optical Add/Drop Multiplexers (OADMs). Where optional optical cross-connect switches are included, these nodes are referred to as Reconfigurable OADMs. In the absence of optical cross-connect switches, the wavelengths dropped and added are hardwired to the Tributary Port protection switches, receivers and wavelength-specific transmitters.

In the case of Reconfigurable OADMs, optical cross-connect switches and optical splitters can be used to form various connection options, including pass-thru, add/drop and drop & continue.

As for mesh networks, IR optical amplifiers can be added to some or all nodes, or between nodes, to compensate for path losses due to fibre length, optical mux/demux filters, optical splitters and optical switches.

As for the previous Mesh network example, only unidirectional connections are described and two uni-directional connections must be established to form a bi-directional connection.

(i) Protection Switching Options

As for the mesh network examples, 1+1 protection switching can be implemented on a per-wavelength basis. FIG. 13 shows for example a Working Path 78 (via the West port) and a Protection Path 80 (via the East port). This is sometimes referred to as Optical UPSR (Uni-directional Path Switched Ring). In this example, the path protection switch is shown as part of the tributary port 72. As described in the mesh network examples, the path protection switch can also be integrated into the cross-connect switching function if this exists.

WDM Ring networks can also use Bi-directional Line Switched Ring (BLSR) protection on a per-wavelength basis. This is a form of 1:1 (1 for 1) path protection switching, since the data transmitted by a tributary port to the Working Path need not necessarily be broadcast simultaneously to a Protection Path. More complex physical-layer signalling may be required to create the Protection Path and to connect the tributary transmitter to the tributary receiver via this path.

In WDM BLSR-protected ring networks where wavelength re-use is employed, higher-layer connection signalling is also required to disconnect lower priority services that were consuming the spare (protection-path) capacity prior to the failure event. Since some of the spare capacity is used prior to any failure, such a network is not strictly set-up with 1:1 protection.

For ring networks, SONET, SDH, FDDI and RPR all support BLSR protection. SONET and SDH can also use 1+1 or UPSR protection in mesh, ring and linear bus networks. WDM networks can support all these path protection options on a per-wavelength basis.

As for the mesh network examples, different algorithms may be used in different embodiments to make path switching decisions (whether 1+1, Optical UPSR or BLSR).

(j) Optical UPSR (1+1) Protection Switching Examples

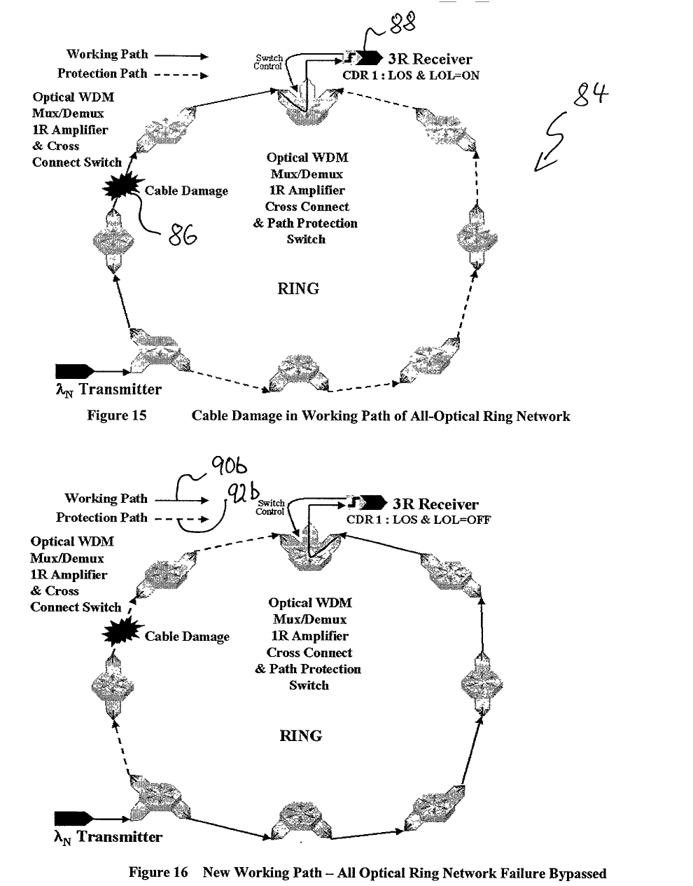

FIG. 14, FIG. 15 and FIG. 16 reproduce for a ring network 84, similar path protection switching events and 3R Receiver alarm states that were outlined for the mesh network example. In all these figures, the path protection switch is shown integrated with the optical cross-connect switch. Whilst all ring-nodes may include tributary ports, only the tributary ports for a single end-end service are shown for simplicity.

FIG. 14 shows a normally operating all-optical ring network 84 with working path 92 and protection path 90.

FIG. 15 shows cable damage 86 and the 3R Receiver 88 LOS and LOL alarms going to the ON state.

Following operation of the path protection switch, FIG. 16 shows the new Working Path 90b and the LOS and LOL alarms in the OFF state again.

OEO Ring Network

(k) Reconfigurable OEO-ADM Nodes

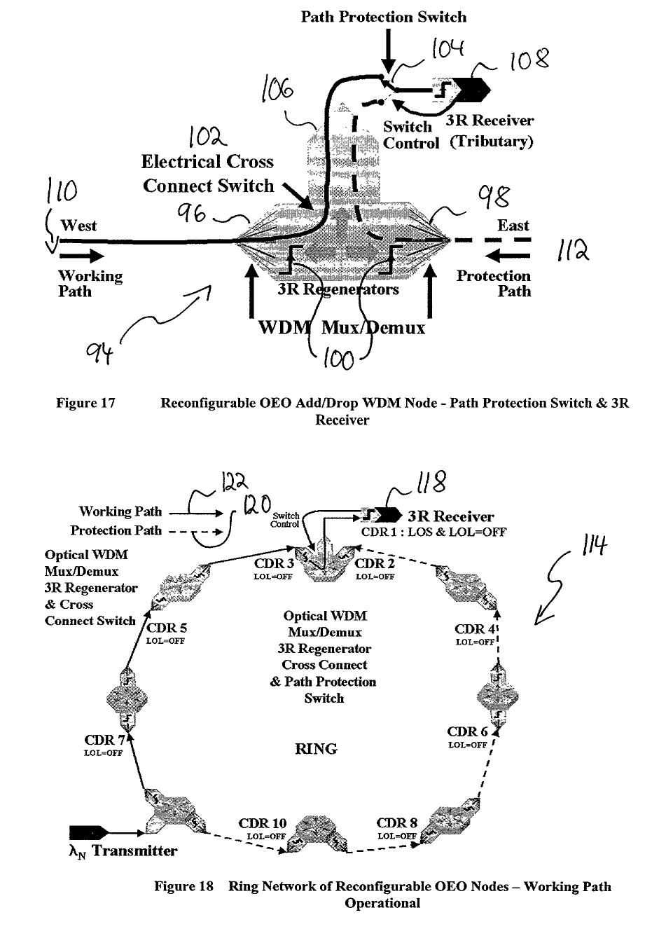

As illustrated in FIG. 17, a OEO ring network implementation employs OEO Add/Drop Multiplexer (ADM) nodes 94 with WDM mux/demux filters on the East and West ports 96, 98 and 3 R regeneration on all wavelengths as illustrated at numeral 100. Electrical cross-connect switching 102 may optionally be fitted to each OEO node 94.

Also shown in FIG. 17, is the path protection switch 104—located on the tributary port 106, the tributary port 3R Receiver 108 (and associated CDR). The Working Path 110 for this tributary port 106 is shown coming from the West Port 96 and the Protection Path 112 for this tributary port 106 is shown coming from the East Port 98.

As previously stated, the path protection switch can optionally be integrated with the electrical cross-connect switch (where fitted). When the electrical cross-connect switch is fitted, this is referred to as a “Reconfigurable” OEO-ADM node.

Since each OEO-ADM node 94 provides 3R regeneration, it will generally be unnecessary to include 1R optical amplification as well—although this is not prevented if longer transmission distances are required between adjacent nodes.

### (1) OEO UPSR (1+1) Path Protection Switching Examples

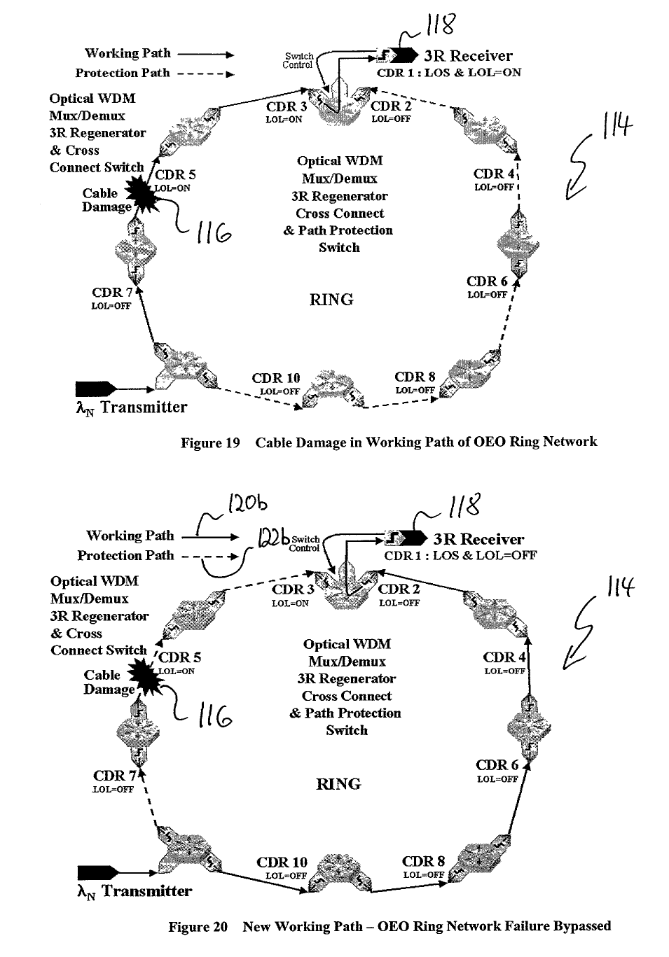

FIG. 18, FIG. 19 and FIG. 20 reproduce for a OEO ring network 114, similar path protection switching events 116 and 3R Receiver 118 alarm states that were outlined for the mesh network and the all-optical OADM ring network examples. In all these figures, the path protection switch is shown integrated with the optical cross-connect switch. Whilst all ring-nodes may include tributary ports, only the tributary ports for a single end-end service are shown for simplicity.

FIG. 18 shows a normally operating OEO ring network 114 with working path 122 and protection path 120.

FIG. 19 shows cable damage 116 and the CDR's downstream of the failure 116 (#5, #3 and #1—3R Tributary Receiver 118) with their LOL alarms in the ON (failure) state. As for the mesh network example, the first CDR (#5 in this case) after the point of failure 116, automatically and rapidly propagate the fault condition (LOL) to downstream nodes and ultimately the end tributary Receiver 118. This is referred to as “fault notification” and it is reported to downstream neighbour nodes using physical layer signalling.

Fault notification is achieved by using the LOL alarm output to force the CDR output to a static (all 1's or all 0's state). Depending on how each node's laser transmitter driver is designed, this may result in the laser output going to the laser power low or laser power high states. In any case, this will be a DC signal which for normally AC-coupled receivers, will be blocked, resulting in zero signal input to the 2R binary detector and a static signal input to the next CDR, thus resulting in both LOS and LOL alarm states=ON.

The tributary 3R Receiver 118 LOS and LOL alarms going to the ON-state is fed into the path-switching control algorithm. Following operation of the path protection switch, FIG. 20 shows the new Working Path 120b and the tributary Receiver 118 LOS and LOL alarms going to the OFF state again. The CDRs (#5 and #3) on the new Protection Path following the fault will continue to show LOL=ON until such time that the fault is repaired.

Hybrid Optical ADM and OEO ADM Networks

The embodiments described above relate to path fault detection and fault notification mechanisms for all-optical and OEO network implementations. However, the invention can similarly be applied to hybrid networks comprising nodes that support Optical add/drop multiplexing (with or without optical cross-connect switching) for some wavelengths and OEO add/drop multiplexing (with or without electrical cross-connect switching) for other wavelengths.

Multi-rate CDR Based Fault Detection & Notification

(m) Review and Summary of Requirements in Preferred Embodiments

Whether a WDM network is a mesh, linear bus or ring, all-optical, or OEO, the fact that it uses wavelength division multiplexing generally means that multiple different protocols and associated data rates must be supported.

Each of these different protocols and data rates must be monitored to detect path faults. Such faults may be due to a fibre (cable or interconnect) break, connector removal, component failure or loss of electrical power for example.

In the case of all-optical networks, detection of a path fault may first occur at the end tributary port of a path. In the case of OEO networks, detection of a path fault may first occur at the node immediately downstream of the fault. In both cases, the embodiments described rely on the presence of a multi-rate CDR being present at the end tributary receiver (a 3R Receiver). For OEO networks, this invention take into account that there may also be a CDR at each node in the path between the fault and the end tributary receiver and that such CDRs can generate pseudo-data from noise.

In all cases, the multi-rate CDR based fault detection mechanism substitutes for other fault detection mechanisms such as: FDM multiplexing and monitoring of sub-carrier tones; TDM multiplexing and monitoring of PRBS test patterns; or unobtrusive monitoring of the 1R signal shape or signature.

It is an objective of all such fault detection mechanisms, that they be able to detect the difference between real data and pseudo-data or spurious noise sources (eg, due to optical amplifiers). In other words, accurate fault detection in the presence of noise requires some level of correlation (pattern-matching). Greater correlation generally takes more time and for maximum availability, there is a tradeoff between the objectives of maximum certainty and minimum detection time.

For maximum network availability, 1+1 path protection switching is often used, with the path protection switch and associated controller located as close as possible to the end tributary receiver. Once a fault has been detected, it is desirable that the existence of the fault be conveyed as quickly as possible to the path protection switch controller. Physical layer signalling (rather than higher-layer signalling) of the fault-detection information to the protection switch controller is therefore desirable. This is referred to as “fault notification” in the embodiments described.

The protection switch control algorithm may take the fault detection information and combine it with historical data and pre-programmed path bias information to make a path-switching decision. Such path-switching algorithms are beyond the scope of this invention.

(n) Multi-rate CDR Description

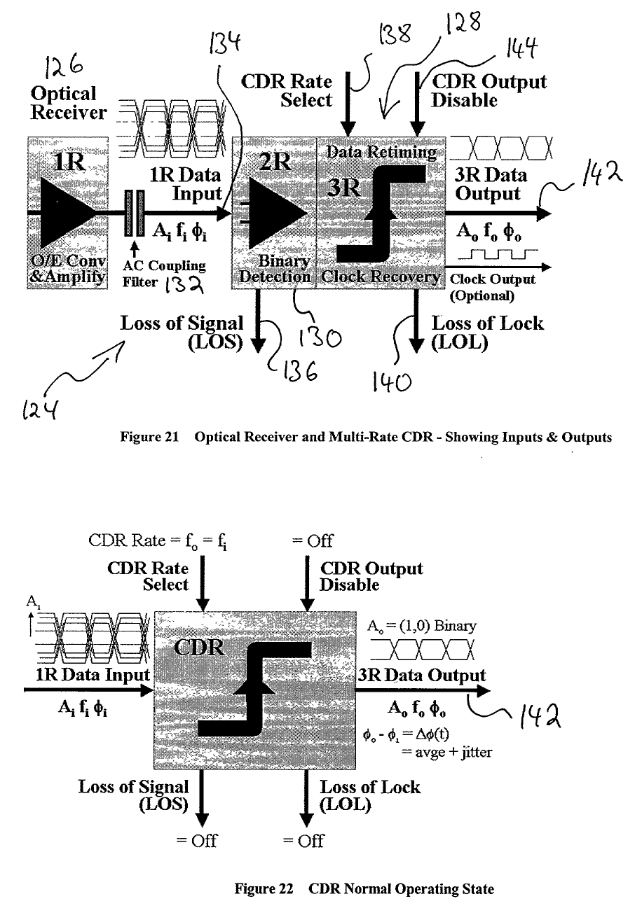

FIG. 21 shows a schematic representation 124 of a Optical Receiver 126 AC-coupled to a multi-rate CDR 128, with its various inputs and outputs. The particular CDR 128 shown includes the 2R re-shaping function 130, and as such can be connected directly to the output of a 1R Optical Receiver 126 at the end tributary port, or at any other OEO node along the path. The 1R Optical Receiver 126 combined with the multi-rate CDR 128 form the 3R Receiver function described previously.

Since the multi-rate CDR 128 shown in FIG. 21 has visibility of the 1R Optical Receiver 126 output, it therefore is able to generate a LOS alarm based on the received optical signal level. Where the CDR does not possess this capability, or have access to this information, it is possible to instead obtain the LOS information directly from the associated 1R Optical Receiver 126 itself. Since both possibilities are covered, it is sufficient to continue to assume that the multi-rate CDR 128 shown in FIG. 21 adequately represents all the information that is important for detecting a signal fault associated with a particular wavelength in either an all-optical or a OEO network.

The CDR inputs and outputs shown in FIG. 21 are described below:

1R Data Input 134

The output of the 1R Optical Receiver 126 associated with a given wavelength is connected via an AC Coupling Filter 132 to the 1R Data Input 134 of the CDR 128. It is normally an analog-like signal in the sense that it can have variable amplitude “Aᵢ” due to variable losses in the optical fibre path that the wavelength has traversed. The signal has a digital origin with average symbol-rate “f₁”. It arrives at the CDR input 134 with phase “φᵢ” with respect to a relatively stable, low jitter, local reference clock having the same average frequency “fᵢ”, that is derived from the transitions in the input data signal. The purpose of the AC Coupling Filter 132 is to simplify the 2R Binary Detection process for input signal amplitudes having a wide dynamic range (over 30 dB for some APD type optical receivers).

Loss of Signal (LOS)—Alarm Output 136

When the absolute value of the CDR data input amplitude “Aᵢ” falls below a pre-set threshold low-level, the LOS alarm goes to the ON state. When the absolute value of the CDR data input amplitude “Aᵢ” rises above a pre-set threshold high-level, the LOS alarm goes to the OFF state. Generally, there will be a gap between the threshold-low and the threshold-high levels—providing hysteresis—to minimise the likelihood of LOS oscillation between the ON and OFF states due to signal amplitudes that are on the borderline between the threshold-low and threshold-high levels.

The above hysteresis logic is normally included as part of the 2R (signal reshaping) stage 130 within the CDR 128. It is normal for a 2R signal reshaping stage to maintain the 2R output at a constant (static) level when the absolute value of the data input amplitude “Aᵢ” stays below the pre-set threshold low-level. This static output level is either a binary 1 or a binary 0, depending on the last valid symbol received prior to the signal input amplitude falling below the low-threshold level.

In the event that the CDR does not include the 2R signal reshaping stage and does not have a LOS alarm output, this 2R reshaping stage and the LOS detector logic can be provided separately between the CDR and the associated optical receiver without any change to the path fault detection mechanism described.

CDR Rate Select—Control Input 138

This represents an input through which the CDR reference clock is pre-programmed to the data rate to be used for the particular wavelength. The reference clock frequency will nominally be the same as the data rate specified for the chosen protocol, and will synchronise to the exact input data rate by comparing its frequency and phase with the incoming data transitions.

Loss of Lock (LOL)—Alarm Output 140

The CDR 128 has a very narrow lock-in range, so unless there is high correlation between the data rate of the received signal with the data rate pre-programmed into the CDR 128, it will not lock or stay locked, and so the LOL alarm will be in the “ON” state. If the input signal is random noise for example, then this will have highly varying transition frequency and phase which will have low correlation with the pre-programmed data rate and associated transition interval. The LOL output will thus go to the ON state indicating that there is no valid data signal on the 1R Data Input.

Even when there is a signal on the 1R Data Input 134 that originated from a tributary Transmitter with the correct data rate, unless this signal has a high enough Signal to Noise Ratio (SNR) and a low enough “effective” Bit Error Rate (BER), it will not attain sufficient correlation to allow the reference clock to synchronise or to stay synchronised. For a given protocol and data rate, the “effective” BER can be calculated mathematically based on the SNR and the electrical filter response of the 1R Optical Receiver 126 (which is known and fixed). The CDR LOL alarm will stay in the ON state until the “effective” BER attains a low enough value—eg, <10³. The CDR method of fault detection therefore includes a coarse level of “performance monitoring”.

3R Data Output 142

The reference clock derived from the data transitions is used internally within the CDR 128 to “clean-up” or de-jitter the input data signal by retiming each received symbol—nominally in the centre of the symbol—to regenerate a binary digit (bit), which then appears at the CDR 3R Data Output 142. This is called 3R regeneration. The reference clock may also be available externally to the CDR 128 for other applications—such as more informative performance monitoring—but this is beyond the scope of this invention.

When enabled, the 3R Data Output 142 shown in FIG. 21 and FIG. 22 has the following attributes:

“Aₒ” which is the bit amplitude and has binary values “0” and “1”;

“fₒ” which is the output bit rate, which for binary symbols, is nominally equal to the input bit rate “fᵢ” when the CDR reference clock is locked to the incoming data transitions; and

“φₒ” which is the relative phase of the 3R Data Output transitions.

The output data transition timing is normally derived directly from the reference clock and so when operating normally, the difference value “φ^{o}−φⁱ” should on average be fixed but over shorter sample-periods, provides another measure of input signal quality—being relative phase jitter. This is shown as Δφ(t) in FIG. 22.

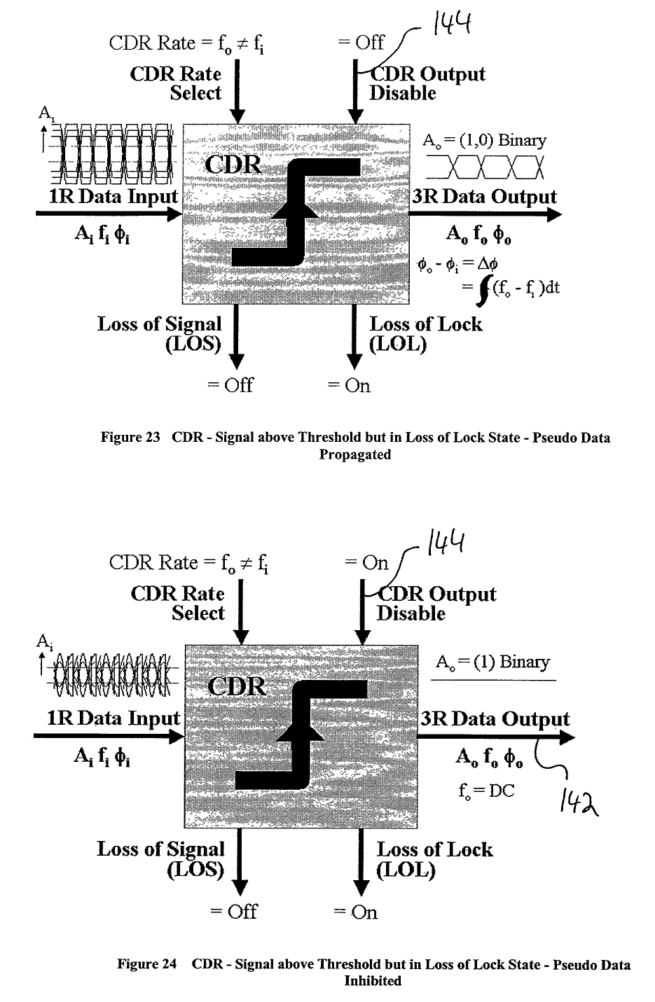

Note that if the CDR reference clock is not locked to the 1 R Data Input signal, and if the CDR Output is “enabled”, then pseudo-data can emerge from the 3R Data Output 142 with a bit rate which is nominally equal to the pre-set data rate. This is shown in FIG. 23. Unless this error condition is curbed, it can have the effect in an OEO network, of causing the downstream CDR's including the end-tributary CDR to lock onto the pseudo data and thus falsely indicate that the data path is operating normally.

CDR Output Disable—Control Input 144

When a local controller applies an appropriate ON-signal level to the CDR Output Disable input, the 3R Data Output driver is disabled and the output signal goes to a static state (either all-1s or all-0s). When a local controller applies an appropriate OFF-signal level to the CDR Output Disable input, the 3R Data Output driver is enabled and the output signal is as described under 3R Data Output.

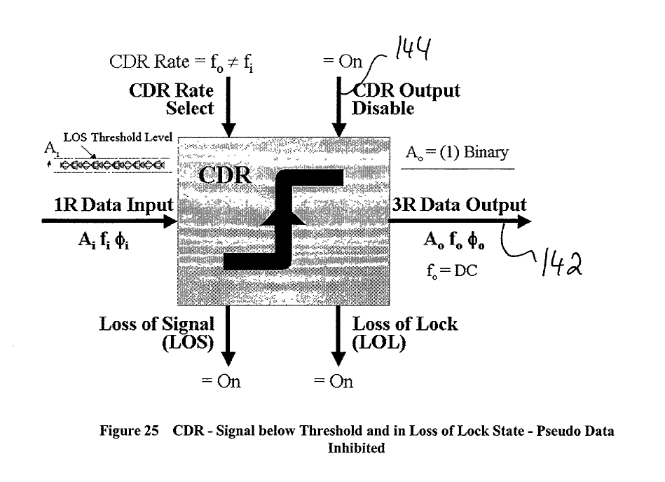

In a preferred embodiment, if a CDR along a transmission path has its LOS alarm state=ON or its LOL alarm state=ON, then the local controller must force the CDR Output Disable input to the ON-signal level and thus disable the 3R Data Output. As shown in FIG. 24 and FIG. 25, this then causes a static (all-1s or all-0s) data signal to propagate downstream to all subsequent CDRs, including the end-tributary CDR. This will then be detected by the end-tributary controller. This is a “fault notification” mechanism that uses physical layer signalling in the form of the all-1s or all-0s static state. The path fault detection state at the end tributary receiver will then be passed to the path switching control logic.

(o) Fault Notification to Downstream Neighbours

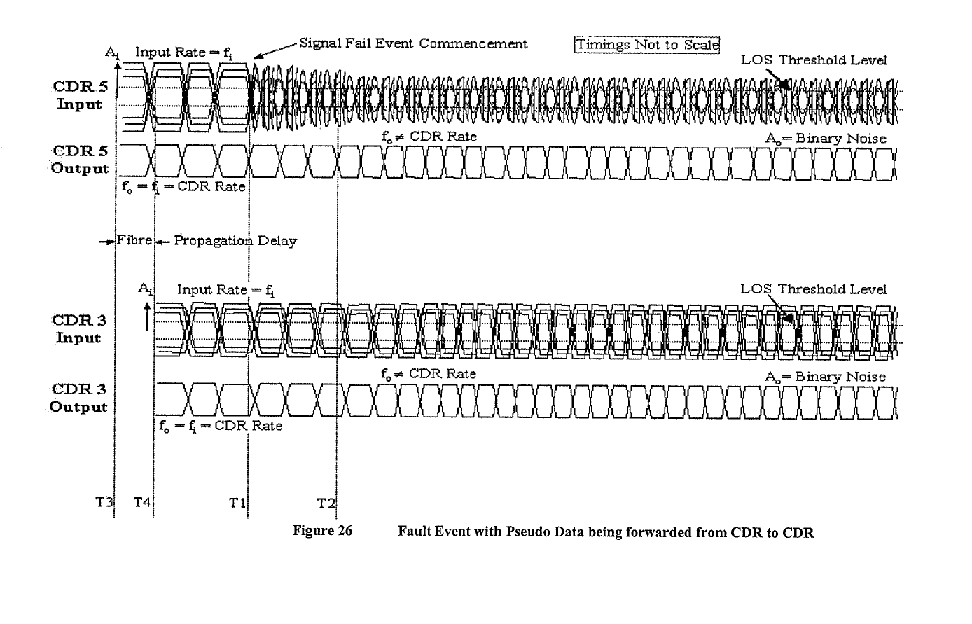

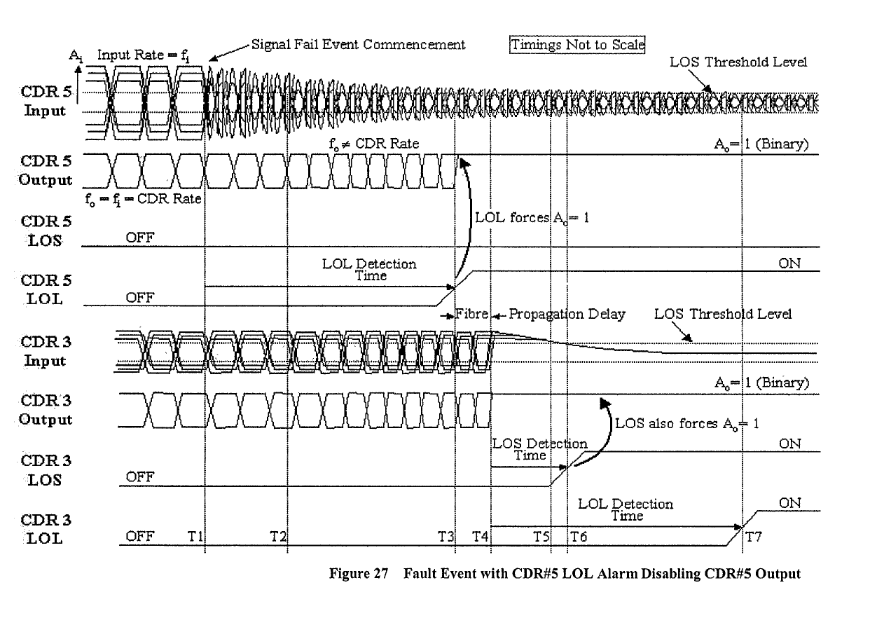

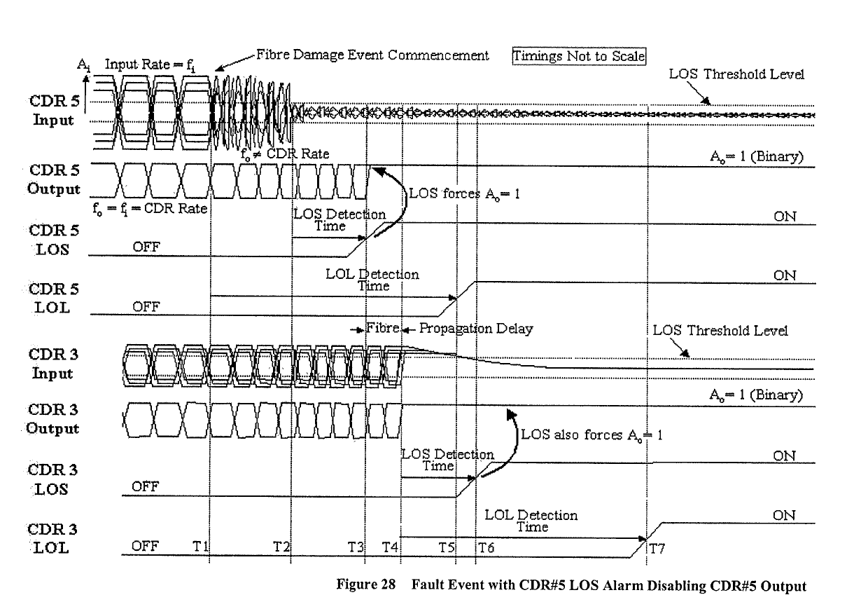

FIG. 26 illustrates a failure event and the undesirable propagation of pseudo data to the downstream OEO nodes shown in FIG. 19. FIG. 27 and FIG. 28 illustrate a failure event and the subsequent detection and notification of the failure state to the downstream OEO nodes shown in FIG. 19. This is achieved by the LOL and/or LOS alarms disabling the CDR output to generate the all-1s state (in this example). These figures are explained in more detail below.

FIG. 26 shows events occurring in time at CDR#5 and CDR#3 in FIG. 19. The events between the two CDRs are delayed by time T₄−T₃ being the sum of the transmitter+fibre+receiver propagation delays. Note that the event timings are not to-scale.

At time T₁ a signal failure event commences. The signal is shown to diminish in amplitude but not below the LOS threshold level, and its transitions become random in time when compared with the valid data pattern shown prior to the failure. This failure pattern might occur for example, due to a fibre break and a optical amplifier generating random noise in place of the original data pattern.

Prior to the signal failure event, the CDR#5 output data rate, input data rate and the nominal CDR rate (programmed into it) are all equal. After the signal failure event, the CDR generates pseudo data at its output with a rate fₒ which may be offset in frequency from the nominal CDR rate, but close enough for the next downstream CDR#3 to lock onto. This possibility is shown in FIG. 26 and is not desirable since CDR#3 cannot recognise this as a failure and consequently passes the pseudo data onto CDR#1. This end-tributary CDR may similarly interpret the pseudo data as valid data and thus not cause the path protection switch to operate to bypass the faulty path.

FIG. 27 illustrates a fault event where the fault is apparent immediately at time T₁ but the signal amplitude falls slowly below the LOS threshold level. The purpose of this figure is to show the LOL alarm occurring before the LOS alarm due to high but non-valid input data signals.

In this figure, the failure event results in pseudo data at data rate fₒ being passed downstream from CDR#5 to CDR#3. The CDR#5 LOL detection time is shown to be of duration T₃−T₁. At the end of this detection time, the LOL alarm goes to the ON state and as required by this invention, this causes the CDR#5 output driver to be disabled. The CDR#5 output goes to a static all-1s state.

This all-1s notification state continues downstream to CDR#3 which eventually detects this state as a Loss of Signal condition. The CDR#3 LOS detection time is the time it takes for the CDR#3 input signal amplitude to droop below the LOS threshold level. This droop is due to the use of AC-coupled receivers in fibre communications links. The droop time is designed to be much greater than the longest string of Consecutive Identical Digits (all 1s or all 0s) for any given protocol and data rate, or is pre-set for the worst-case protocol and data rate, so that pattern dependent jitter and associated degradation to receiver sensitivity is limited to an acceptable level.

In FIG. 27, the interval T₄−T₃ is the transmitter+fibre+receiver propagation delay. The CDR#3 LOS detection time is the interval T₆−T₄. The LOS alarm going to the ON state will result in the CDR#3 output driver being disabled, however, this is a precaution only in this case, since the CDR#3 output has already been in the all 1's notification state for quite a while due to CDR#5 having gone to a static logic 1 level, and in addition to this, the hysteresis designed into the 2R receiver stage will have prevented the CDR#3 output from changing once the input signal amplitude drooped below the LOS threshold level.

Also shown in FIG. 27 is the CDR#3 LOL alarm going to the ON state. This is logic OR'd with the LOS alarm to disable the CDR output. Since the CDR#3 output is already disabled due to the LOS alarm, the LOL alarm is in this case, redundant (but still needed for other situations).

As evident from FIG. 27, the maximum time required for the failure event to be detected at CDR#3 is CDR#5 LOL detection time+CDR#3 LOS detection time. This is the maximum period of time that invalid data is forwarded by CDR#3 before an alarm is raised, and does not (and should not) include any transmitter+fibre+receiver propagation delays.

In these figures, the LOL detection time (T₇−T₄) is shown to be longer than the LOS detection time (T₆−T₄), which will normally be true for the worst case protocol and data rate. As for the AC-coupled receiver, the CDR clock must be able to maintain its phase coherence for the time interval since the last data transition, which is determined by the longest string of Consecutive Identical Digits (all Is or all Os) for the pre-programmed protocol and data rate. The CDR includes a loop filter which has a long-enough response time to guarantee phase coherence and to keep any pattern dependent jitter within acceptable levels. For some multirate CDRs, the loop filter response is programmable to match the characteristics of the protocol and data rate.

In the case of data-centric protocols with well constrained line codes, such as 8B/10B, there may be a maximum of 5 Consecutive Identical Digits (CID). If the receiver AC-droop is fixed and designed for the worst case protocol and data rate (eg, SONET OC3 with a data rate of 155.52 Mbit/s and a CID=72) and the multirate CDR is programmed for the exact protocol, data rate and loop filter response (eg, Gigabit Ethernet with a data rate of 1.25 Gbit/s and a CID=5), then it is feasible in this case, for the LOL alarm to go to the ON state before the LOS alarm. Since according to this invention, these two alarms are OR'd, then it is of no consequence which alarm goes to the ON state first. The objective and result will be to detect the failure event and disable the CDR output as soon as possible—with a low probability of false fault detection.

FIG. 28 illustrates a fault scenario where the signal amplitude falls below the CDR#5 LOS threshold very quickly (time interval T₂−T₁). Once the signal has fallen below this threshold, there is a LOS detection time (T₃—T₂) which is designed to be long enough to minimise the probability of false LOS detection due to transitory signals and noise. The CDR#5 LOS alarm then goes to the ON state which disables the CDR output—forcing the all-1s logic level in this example.

The all-1's state is a “fault notification” state which gets forwarded downstream to CDR#3. When this signal is applied to the AC-Coupling filter at the CDR#3 input, droop occurs after a long period of Is, causing the signal to fall below the CDR#3 LOS threshold (at time T₅). This causes the LOS alarm to go to the ON state, which then disables the CDR#3 output—thus guaranteeing that the all-1s static signal level is maintained and propagated to other downstream nodes.

In this example, the total fault detection time is equal to the sum of the transitory noise interval T₂−T₁ plus the CDR#5 LOS and the CDR#3 LOS detection times. This assumes that the LOL detection time is greater than the transitory noise interval T₂−T₁ plus the CDR#5 LOS detection time. If the AC-coupling filter and associated LOS detection times are fixed and based on the worst case protocol and data rate (eg, SONET OC3), then for a AC-coupling low frequency roll-off of 50 kHz (needed to achieve acceptable pattern dependent jitter for a string of 72 Consecutive Identical Digits), the total fault detection time will be of the order of 0.1 ms to 1 ms. This value will be dependent on the input signal amplitude (Aᵢ) since larger input signals will take longer to droop below the LOS threshold level (which is normally fixed to detect low average signal levels).

(p) Improvement to Fault Detection Logic & Notification Time

An improvement to this invention would be for the first CDR (eg, CDR#5 in FIG. 19) that detects a fault condition to send the resultant CDR Output Disable control signal to the laser transmitter associated with that node and wavelength-path. When applied to a (newly defined) Laser Output Disable input to the laser transmitter, the associated transmitter driver would switch the laser output power to a 3^{rd} (non-binary) state, being at the mid-point between the logic 1 and the logic 0 states (analogous to the Tri-State Output in some digital logic devices).

This 3^{rd} (non-binary) level would be followed accurately and rapidly by the next downstream optical receiver (within the rise/fall time of the highest data rate used). The impact of subjecting this 3^{rd} (non-binary) level to the 2R binary detection stage following this receiver is to short-circuit or cut-through the droop-time normally associated with the AC-coupling filter between the 1R Receiver and the 2R Binary Detector. Since the 2R detection stage should include the hysteresis circuit mentioned previously, then the result of the 3^{rd} (non-binary) input level should be to maintain the 2R detector output and the CDR output at the last valid binary level received, with little probability of random transitions. The CDR output (eg, CDR#3 in FIG. 19) will therefore be forced to the static all-Is or all-Os fault notification state very quickly (in less than a bit period).

However, forcing the CDR output to a static state is not in itself an indication of signal failure—the normal LOS or LOL detection time must still be applied before this static state can be interpreted as a failure state. To overcome this problem, a 3-Level Detector is added after the 1R Receiver output. This 3-Level Detector is designed to detect the two valid binary states (optical power high, optical power low) as well as the intermediate state (optical power at mid-point between high and low). The intermediate (3^{rd}) optical signal state must be detected in this state for a period of at least 1 bit interval to be able to differentiate this state from a signal condition that is transitory between the high and low optical power states.

The “fault notification” state that is signalled within the physical layer to downstream neighbour nodes is the 3^{rd} optical state—for which the laser is transmitting at a optical power level mid-way between the logic 1 and logic 0 binary states. This fault notification state only exists “in-band” as one of three states, between the laser output and the receiver output. Once it is detected by the 3-Level Detector, it exists “out-of-band” as a particular logic state (eg, ON-state) between the 3-Level Detector Output and the Laser Output Disable input.

When the intermediate (3^{rd}) optical signal state is detected, this condition would be used to raise another LOS(2) alarm output to the ON-state. The three alarm states: LOS, LOS(2) and LOL would then be OR'd as before to generate the summary alarm state which is used to disable the CDR output and the associated laser transmitter output (as outlined above). This fault detection information is thus available within 1 bit period and can be signalled immediately to downstream nodes by similarly forcing the associated laser output power to the 3^{rd} “fault notification” state.

In some Multi-rate CDR embodiments, where the 2R Detector stage is integrated into the CDR, the LOS alarm output could be designed to include the detection of this 3^{rd} optical input state. The LOS(2) alarm state would therefore only exist within the CDR device.

The end-end fault detection time will be the sum of the first fault detection time (LOS or LOL) for CDR#5 for example in FIG. 19, plus the time to transmit and detect the “fault notification” state (being 1 bit period for the data rate programmed into the CDRs—multiplied by the number of downstream 3R nodes after the first node to detect the fault). For some protocols with highly constrained line codes, such as Gigabit Ethernet, this end-end fault detection time could be as small as one LOL detection time (>>5 bits) plus N bits where “N” is the maximum number of nodes between two points in the network. For a 50-bit LOL detection time and a 16-node ring for example, the end-end fault detection time for Gigabit Ethernet could be no more than 66 bits or 52.8 ns. Since the path-switching time can be negligible compared to this, the wavelength path downtime will be six orders of magnitude smaller than the SONET path protection time of 50 ms.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

The advantage of embodiments of this invention over other physical-layer fault detection schemes in all-optical and OEO WDM networks is that minimal extra hardware is required to detect faults of various kinds, on a per-wavelength basis. Having minimal hardware to implement the scheme is especially important in multi-node OEO networks where minimal fault-detection hardware per wavelength per node is desirable.

The Multi-rate CDR devices needed to regenerate data signals to meet jitter specifications for each protocol and data rate, can be used as a means of detecting when a signal has been lost or has been replaced with another noise signal (such as from a optical amplifier). Additionally, for the specific case of OEO networks, a fault notification scheme is described which prevents pseudo-data from being generated and propagated by the CDRs, which could confuse the fault-detection and path-switching process.

A further improvement for OEO networks has also been described, whereby a Tri-state “fault notification” signal, being an optical level mid-way between the optical high and low levels, is used to speed-up the process of notifying downstream neighbour nodes that the path has failed.

A fundamental principle is that the higher the rate at which a signal is sampled and compared to a pre-set, protocol and data-rate dependent template, the faster will be the fault detection time.

The benefit of the CDR based fault-detection technique described is that the signal-integrity sampling rate is of the order of the Data Rate divided by the maximum number of Consecutive Identical Digits (CID). For some protocols, such as Gigabit Ethernet, the data rate is in the Gbit/s range and the maximum CID is as low as 5. As a result, end-end fault detection and path protection switching speeds 6 orders of magnitude faster than traditional SONET fault detection and protection switching (50 ms) is possible.

In the claims that follow and in the summary of the invention, except where the context requires otherwise due to express language or necessary implication the word “comprising” is used in the sense of “including”, i.e. the features specified may be associated with further features in various embodiments of the invention.

1. A node for use in a WDM optical network, the node comprising:
a tributary receiver unit for receiving a data signal distributed via the WDM optical network and destined for said node,
a path protection switching unit for switching receipt of said data signal at the tributary receiver unit from a working path to a protection path of the WDM optical network, and
a control unit for the path protection unit,
wherein the control unit comprises a multi rate clock data recovery (CDR) device arranged, in use, to detect a loss of lock (LOL) in the data signal received at the tributary receiver unit based on a comparison of an actual data rate received and a pre-programmed reference rate for said data signal.

2. A node as claimed in claim 1, wherein the CDR device is further arranged, in use, to detect a loss of signal (LOS) in the data signal received at the tributary receiver unit.

3. A node as claimed in claim 2, wherein the CDR device comprises a 1R optical receiver element and a 2R binary detection element for detecting the LOS.

4. A node as claimed in any one of claims 1 to 3, wherein the control unit further comprises a signal quality detector unit for monitoring the quality of the data signal received at the tributary receiver unit.

5. A node as claimed in claim 1, wherein the path protection switching unit comprises an optical switch, and the control unit and the tributary receiver unit are located at the output side of the optical switch.

6. A node as claimed in claim 1, wherein:
the path protection switching unit comprises an electrical switch,
the control unit comprises at least two CDR devices and associated signal quality detectors, all located on the input side of the electrical switch, and
the tributary receiver unit is located on the output side of the electrical switch and arranged as an electrical receiver,
and a pair of one CDR device and one associated signal quality detector is connected, in use, to the working path, and
another pair of one CDR device and one associated signal quality detector to the protection path.

7. A node as claimed in claim 1, wherein the node further comprises:
one or more first network interface units arranged, in use, to demultiplex an incoming WDM optical signal and to convert the incoming WDM optical signal into a plurality of electrical channel signals,
a plurality of 3R regeneration units for regenerating the electrical channel signals, and
one or more second network interface units arranged, in use, to convert and multiplex at least one of the electrical channel signals into an outgoing WDM optical signal.

8. A node as claimed in claim 7, wherein each 3R regeneration unit is arranged, in use, to detect a LOL in its associated electrical channel signal and to force its output to a substantially static state in response to detecting the LOL.

9. A node as claimed in claim 8, wherein the 3R regeneration unit is advantageously further arranged to detect a LOS in its associated electrical channel signal, and to force its output to a substantially static state in response to detecting the LOS.

10. A node as claimed in claims 8 or 9, wherein each 3R regeneration unit is further arranged, in use, to create a laser disable output signal in response to detecting the LOL or LOS, and to transmit the laser disable output to a transmitter laser of the second network interface unit, wherein the transmitter laser is arranged, in use, to switch its laser output to a 3^{rd}, non-binary state in response to the laser disable signal.

11. A node as claimed in claim 10, wherein each 3R regeneration unit is arranged, in use, to detect the 3^{rd}, non binary state in its associated electrical channel signal received from another node, and to maintain its electrical output at the last received binary state when detecting the 3^{rd}, non-binary state.

12. A node as claimed in claim 10, wherein each 3R regeneration unit comprises a 2R regeneration component arranged, in use, such that a gap exists between a threshold-low binary detection state and a threshold-high binary detection state, and the 3^{rd}, non-binary state is chosen, in use, such that it falls within said gap.

13. A node for use in a WDM optical network, the node comprising:
one or more first network interface units arranged, in use, to demultiplex an incoming WDM optical signal and to convert the incoming WDM optical signal into a plurality of electrical channel signals,
a plurality of 3R regeneration units for regenerating the electrical channel signals,
one or more second network interface units arranged, in use, to convert and multiplex at least one of the electrical channel signals into an outgoing WDM optical signal, and
wherein each 3R regeneration unit is arranged, in use, to detect a LOL in its associated electrical channel signal and to force its output to a substantially static state in response to detecting the LOL.

14. A node as claimed in claim 13, wherein each 3R regeneration unit is further arranged to detect a LOS in its associated electrical channel signal, and to force its output to a substantially static state in response to detecting the LOS.

15. A node as claimed in claims 13 or 14, wherein each 3R regeneration unit is further be arranged, in use, to create a laser disable output signal in response to detecting the LOL or LOS, and to transmit the laser disable output to a transmitter laser of one of the second network interface units, wherein the transmitter laser is arranged, in use, to switch its laser output to a 3^{rd}, non-binary state in response to the laser disable signal.

16. A node as claimed in claim 15, wherein each 3R regeneration unit is preferably arranged, in use, to detect the 3^{rd}, non binary state in its associated electrical channel signal received from another node, and to maintain its electrical output at the last received binary state when detecting the 3^{rd}, non-binary state.

17. A node as claimed in claim 16, wherein each 3R regeneration unit comprises a 2R regeneration component arranged, in use, such that a gap exists between a threshold-low binary detection state and a threshold-high binary detection state, and the 3^{rd}, non-binary state is chosen, in use, such that it falls within said gap.

18. A method of conducting path protection in a WDM optical network, the method comprising the steps of:
receiving a data signal at a tributary receiver unit of a network node,
detecting a loss of lock (LOL) in the data signal received at the tributary receiver unit based on a comparison of an actual data rate received and a reference rate for said data signal, and
switching receipt of said data signal at the tributary receiver unit from a working path to a protection path of the WDM optical network.

19. A method as claimed in claim 18, wherein the step of detecting the LOL comprises utilising a multi rate clock data recovery (CDR) device.

20. A method as claimed in claims 18 or 19, wherein the method further comprises the step of detecting a loss of signal (LOS) in the data signal received at the tributary receiver unit.

21. A method as claimed in claim 10, wherein the step of detecting the LOS comprises utilising the CDR device for detecting the LOS.

22. A method as claimed in claim 18, wherein the method further comprises monitoring the quality of the data signal received at the tributary receiver unit.

23. A method as claimed in claim 18, wherein the step of switching to the protection path comprises utilising an optical switch, wherein the tributary receiver unit is arranged as an optical receiver and is located at the output side of the optical switch.

24. A method as claimed in claim 18, wherein the step of switching to the protection path comprises utilising an electrical switch, and the method comprises the steps of:
detecting LOLs and/or LOSs and monitoring the quality of the data signals on both the working and the protection path before the electrical switch, and
wherein the tributary receiver is located on the output side of the electrical switch and is arranged as an electrical receiver.

25. A method as claimed in claim 18, wherein the method further comprises the steps of, at the network node,:
demultiplexing an incoming WDM optical signal and
converting the incoming WDM optical signal into a plurality of electrical channel signals,
regenerating the electrical channel signals utilising 3R regeneration, and
converting and multiplexing at least one of the electrical channel signals into an outgoing WDM optical signal.

26. A method as claimed in claim 25, wherein the step of regenerating the electrical channel signals comprises detecting LOLs in the individual electrical channel signals and to force an output of the 3R regeneration for individual channels to a substantially static state in response to detecting the LOL.

27. A method as claimed in claim 26, wherein the step of regenerating the electrical channel signals further comprises detecting a LOS in the individual electrical channel signals, and to force its output to a substantially static state in response to detecting the LOS.

28. A method as claimed in claims 26 or 27, wherein the method further comprises the steps of:
creating a laser disable output signal in response to detecting the LOL or LOS, and
switching the output of a transmitter laser of the second network interface unit associated with one of the channel signals to a 3^{rd}, non-binary state in response to the laser disable signal.

29. A method as claimed in claim 28, wherein the method comprises the steps of:
detecting the 3^{rd}, non binary state in the electrical channel signals received and converted form another node, and
maintaining an electrical output of the 3R regeneration at the last received binary state when detecting the 3^{rd}, non-binary state.

30. A method as claimed in claim 29, wherein the 3^{rd}, non-binary state is chosen, in use, such that it falls within a gap between a threshold-low binary detection state and a threshold-high binary detection state in the 3R regeneration.

31. A method of conducting fault notification in a WDM optical network from one network node to another, the method comprising the steps of, at said one network node,:
demultiplexing an incoming WDM optical signal and
converting the incoming WDM optical signal into a plurality of electrical channel signals,
regenerating the electrical channel signals utilising 3R regeneration, and
converting and multiplexing at least one of the electrical channel signals into an outgoing WDM optical signal, and
wherein the step of 3R regenerating the electrical channel signals comprises detecting LOLs in the individual electrical channel signals and forcing the output of the 3R regeneration for individual electrical channels to a substantially static state in response to detecting the LOL.

32. A method as claimed in claim 31, wherein the step of regenerating the electrical channel signals further comprises detecting a LOS in the individual electrical channel signals.

33. A method as claimed in claims 31 or 32, wherein the method further comprises the steps of:
creating a laser disable output signal in response to detecting the LOL or LOS, and
switching the output of a transmitter laser of the second network interface unit associated with one of the channel signals to a 3^{rd}, non-binary state in response to the laser disable signal.

34. A method as claimed in claim 33, wherein the method comprises the steps of:
detecting the 3^{rd}, non binary state in the electrical channel signals received and converted from another node, and
maintaining an electrical output of the 3R regeneration at the last received binary state when detecting the 3^{rd}, non-binary state.

35. A method as claimed in claim 34, wherein the 3^{rd}, non-binary state is chosen, in use, such that it falls within a gap between a threshold-low binary detection state and a threshold-high binary detection state in the 3R regeneration.

36. A WDM network comprising a node as claimed in claims 1 or 13.

37. A WDM network arranged, in use, to implement a method as claimed in claims 18 or 31.
